(19) United States
(12) Patent Application Publication
(10) Pub. No.: US 2005/0160778 A1
(43) Pub. Date: Jul. 28, 2005

(54) Locking assembly

(76) Inventor: Rejean Leblond, Victoriaville (CA)

Correspondence Address: Louis Tessier, P.O. Box 54029, Town of Mount-Royal, H3P 3H4, CA

(21) Appl. No.: 11/041,725

(22) Filed: Jan. 25, 2005

(30) Foreign Application Priority Data
Jan. 26, 2004 (CA) 2,455,283

(51) Int. Cl. E05B 27/08

(52) U.S. Cl. 70/491

(57) ABSTRACT

A locking assembly. A key has a key stem, the key stem defining a key-to-actuator contact surface. A lock sleeve defines an inner sleeve surface, the inner sleeve surface defining a substantially longitudinal sleeve longitudinal groove and a substantially circumferential sleeve circumferential groove. A substantially cylindrical lock core defines a core end surface and a key channel extending substantially longitudinally from the core end surface for allowing insertion thereinto of the key, the lock core being supported by the inner sleeve surface for selective rotation within the lock sleeve. A lock piece is slidably mounted to the lock core for slidable movement relative thereto between a retracted configuration and an unlocked configuration. The lock piece includes a lock piece tongue extending substantially outwardly from the core outer surface and a lock piece actuator extending substantially inwardly into the key channel for selective engagement with the key. The key and the lock piece actuator are complementarily configured and sized according to three independent directional parameters so that only a predetermined three dimensional configuration of the lock piece actuator allows for operational contact with the key-to-actuator contact surface upon insertion of the key into the key channel so as to enable the key to move the lock piece longitudinally relative to the lock core from the retracted to the unlocked configuration. In the retracted configuration, the lock core is substantially prevented from rotating relative to the lock sleeve by an abutting contact of the lock piece tongue against the sleeve circumferential groove, and in the unlocked configuration, the lock piece tongue is substantially in register with the sleeve circumferential groove to allow a rotation of the lock core relative to the lock sleeve.

### FIELD OF THE INVENTION

The present invention relates to the general field of security. More specifically, the present invention is concerned with a locking assembly.

### BACKGROUND OF THE INVENTION

A common type of locking assembly includes a cylinder lock and a key. In a cylinder lock, the key turns a cylinder provided within a sleeve. The sleeve and the cylinder receive one or more substantially radially oriented two-parts pins including first and second pin portions. The pins protrude inside a keyhole provided within the cylinder. The key defines a combination profile including bumps and troughs.

The cylinder becomes mobile with respect to the sleeve when the key is inserted within the keyhole and moves the pins so that the first pin portion is received in whole within the cylinder and the second pin portion is received in whole within the sleeve. In this case, the pins do not lock the cylinder with respect to the sleeve and a rotation of the cylinder may actuate a locking device, such as for example a deadbolt or a latch, among others.

One disadvantage of this type of locks resides in a relatively small number of different combinations that are achievable. Indeed, only a relatively small number of pins are typically included in such locks. Also, only a relatively small number of different pin lengths, which determined the number of combinations, are achievable because of manufacturing imperfections in the lock and the key.

Another disadvantage of this type of lock resides in the relatively long time required to change the combination provided by a specific lock. To change such a combination, the lock has to be opened to allow access to the pins. Changing the pins changes the combination of pin lengths and therefore the combination of the key that is required to actuate the locking device. Since the pins are typically spring-loaded within the sleeve to as to be biased towards the keyhole, relatively great care has to be exerted when assembling or disassembling the lock.

Yet another disadvantage of currently existing locks resides in that the lock is often integrated within a handle or a doorknob. If one wishes to use a different lock, there is very often a need to change the whole handle or doorknob. This is relatively time-consuming and relatively expensive.

The number of combinations of existing cylinder locks is also reduced when there is a need to have a master key that may open locks having various combinations and slave keys that may open only a specific lock.

To alleviate at least some of these disadvantages, many other types of locks have been developed. For example, U.S. patent Ser. No. 4,967,578 issued on Nov. 6, 1990 to Sheu et al. describes a lock and a key wherein a combination of the key is determined by the dimensions of longitudinal grooves provided in periphery to the key. Each groove is two-tiered with each tier extending inwardly within the key at a different depth. The longitudinal dimensions of each tier determine the combination encoded by the key.

While a number of combinations that can be encoded by the key described in this document are larger than a number of combinations that can be encoded by similar keys that include grooves of a substantially uniform depth, the number of combinations stays relatively small because of geometric constraints caused by the specific configuration of the lock. For example, the depth of the tier that is inserted the deepest within the lock is necessarily larger than the depth of the other tier.

Against this background, there exists a need in the industry to provide a novel locking assembly.

### OBJECTS OF THE INVENTION

An object of the present invention is therefore to provide an improved locking assembly.

### SUMMARY OF THE INVENTION

In a first broad aspect, the invention provides a locking assembly. A key has a key stem, the key stem defining a key-to-actuator contact surface. A lock sleeve defines an inner sleeve surface, the inner sleeve surface defining a substantially longitudinal sleeve longitudinal groove and a substantially circumferential sleeve circumferential groove. A substantially cylindrical lock core defines a core end surface and a key channel extending substantially longitudinally from the core end surface for allowing insertion thereinto of the key, the lock core being supported by the inner sleeve surface for selective rotation within the lock sleeve. A lock piece is slidably mounted to the lock core for slidable movement relative thereto between a retracted configuration and an unlocked configuration. The lock piece includes a lock piece tongue extending substantially outwardly from the core outer surface and a lock piece actuator extending substantially inwardly into the key channel for selective engagement with the key. The key and the lock piece actuator are complementarily configured and sized according to three independent directional parameters so that only a predetermined three dimensional configuration of the lock piece actuator allows for operational contact with the key-to-actuator contact surface upon insertion of the key into the key channel so as to enable the key to move the lock piece longitudinally relative to the lock core from the retracted to the unlocked configuration. In the retracted configuration, the lock core is substantially prevented from rotating relative to the lock sleeve by an abutting contact of the lock piece tongue against the sleeve circumferential groove, and in the unlocked configuration, the lock piece tongue is substantially in register with the sleeve circumferential groove to allow a rotation of the lock core relative to the lock sleeve.

Advantageously, the lock allows for a relatively large number of different three-dimensional configurations of the lock piece actuator. Having a three-dimensional configuration increases a number of configurations relatively to a number of combinations provided by one-dimensional and two-dimensional configurations for similar configuration complexities.

In addition, some embodiments of the invention include a plurality of actuators. In this case, a number of three-dimensional configurations of all the lock piece actuators increases relatively rapidly with the number of lock piece actuators present in the lock.

The locking assembly also provides for a relatively easy and fast exchange of lock pieces with alternative lock pieces to change the three-dimensional configurations of all the lock piece actuators. In some embodiments of the invention, the three-dimensional configurations of the lock piece actuators is changeable without requiring extra-assembly parts to be provided. In other words, the three-dimensional configurations the lock piece actuators is changed without removal or addition of any part to the locking assembly.

In some embodiments of the invention, the locking assembly is retrofittable to a conventional lock. Therefore, the benefits of the present invention are relatively easily brought to currently existing locks.

The locking assembly also relatively easily allows to have a master key and a sub-master key without greatly reducing the usefulness of the locking assembly through a relatively large reduction in a number of lock combinations available.

Another advantage of the locking assembly is that in some embodiments of the invention, a relatively large number of different three-dimensional configurations is achievable using relatively few distinct part.

In a variant, the locking assembly includes a plurality of lock pieces, each including a respective lock piece tongue and a respective lock piece actuator. The lock piece actuators each include a key contacting extension and the key is provided with a plurality of key grooves.

The key grooves each engage a respective key contacting extension. Only appropriately configured key grooves engage the key contacting extensions so as to enable the key to move the lock piece longitudinally relative to the lock core from the retracted to the unlocked configuration. Inappropriately configured key grooves engage the key contacting extension so that at least one of the lock piece is in a retracted configuration.

In another broad aspect, the invention provides a locking assembly including a plurality of lock pieces.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the Appended Drawings:

FIG. 1 is a perspective view of a locking assembly according to the invention, the locking assembly including a key, and a lock core received within a lock sleeve;

FIG. 2 is a schematic perspective view illustrating the key and too lock pieces mountable to the lock core of FIG. 1, the lock piece including a lock piece stem, a lock piece actuator and a lock piece tongue;

FIG. 3a is a perspective view illustrating a first type of lock piece actuator usable with the lock piece stem of FIG. 2;

FIG. 3b is a perspective view illustrating a second type of lock piece actuator usable with the lock piece stem of FIG. 2;

FIG. 3c is a perspective view illustrating a third type of lock piece actuator usable with the lock piece stem of FIG. 2;

FIG. 4 is a side cross-section view of the lock piece of FIG. 2;

FIG. 5 is a front cross-section view of the lock piece of FIG. 2;

FIG. 6 is a top elevation view of the lock piece of FIG. 2;

FIG. 7 is an exploded side cross-section view of the locking assembly of FIG. 1 without the key;

FIG. 8 is a side cross-section view of the locking assembly of FIG. 1 with the key partially inserted within the lock core, the lock pieces being in a retracted configuration;

FIG. 9 is a side cross-section view of the locking assembly of FIG. 1 with the key abutting the lock pieces, the lock pieces being in an unlocked configuration;

FIG. 10 is a back cross-section view of the locking assembly of FIG. 1 taken along the line 10-10 of FIG. 8;

FIG. 11 is a back cross-section view of the locking assembly of FIG. 1 taken along the line 11-11 of FIG. 8;

FIG. 12 is a cross-sectional view showing the insertion of the lock sleeve of the locking assembly of FIG. 1 into a conventional cylinder lock;

FIG. 13a is a schematic view of a profile of an alternative key;

FIG. 13b is a schematic view of a profile of another alternative key;

FIG. 14 is a side cross-sectional view of an alternative lock piece;

FIG. 15 is a perspective view illustrating a fourth type of lock piece actuator usable with the lock piece stem of FIG. 2;

FIG. 16 is a top elevation of an alternative key stem;

FIG. 17 is a front elevation view of the key stem of FIG. 16; and

FIG. 18 is a side elevation cross-sectional view of the key stem of FIG. 16 along the line 18-18.

### DETAILED DESCRIPTION

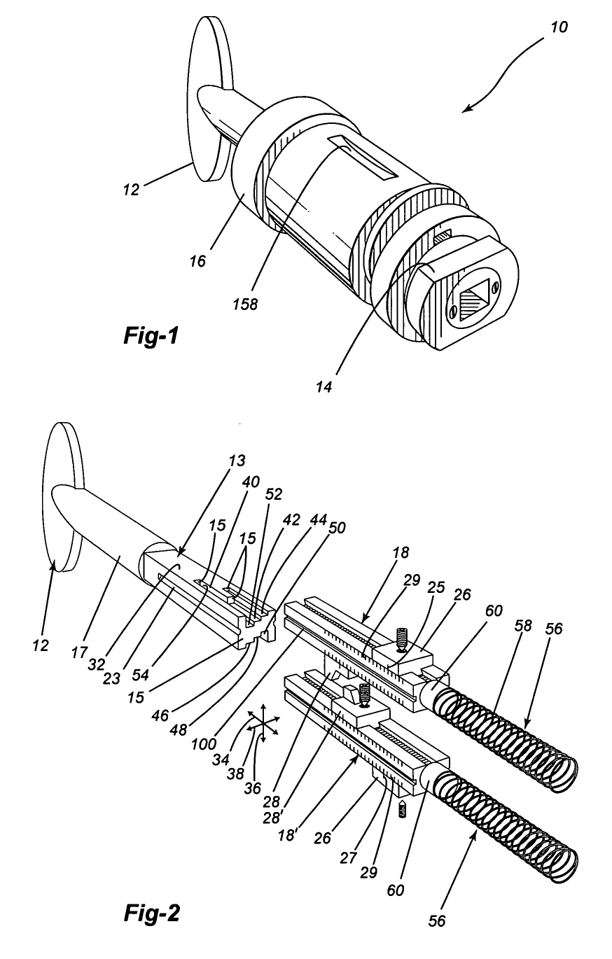

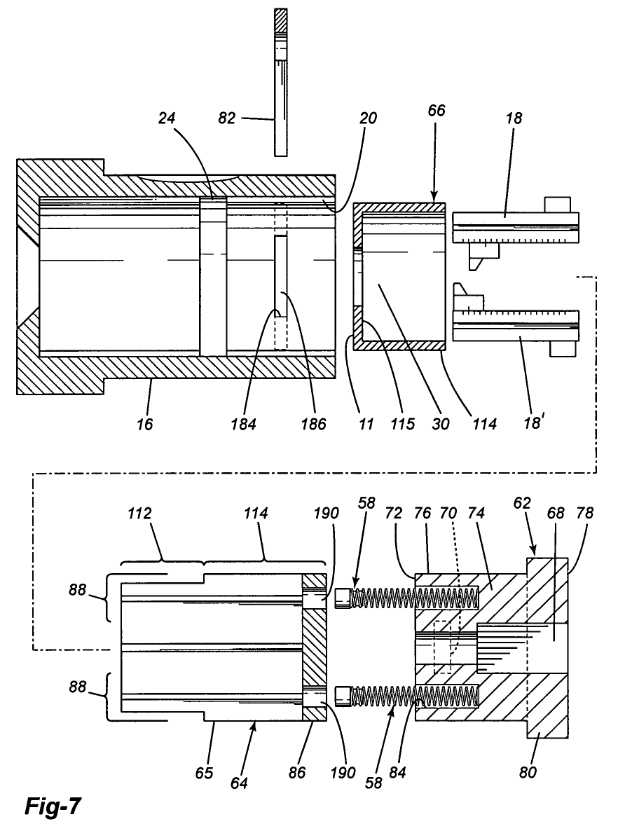

FIG. 1 shows a locking assembly 10 including a key 12 and a lock core 14 provided within a lock sleeve 16. The lock core 14 is provided with a key channel 30 (better seen in FIG. 7) for allowing insertion thereinto the key 12. As shown in FIG. 2, the key 12 has a key stem 13, the key stem defining a key-to-actuator contact surface 15 (only partially shown in FIG. 1).

The lock core 14 is substantially cylindrical and defines a core end surface 11 (seen in FIG. 7). The key channel 30 extends substantially longitudinally from the core end surface 11.

As seen in FIGS. 7-10, the lock sleeve 16 defines an inner sleeve surface 20. The inner sleeve surface 20 defines a substantially longitudinal sleeve longitudinal groove 22 (better seen in FIG. 11) and a substantially circumferential sleeve circumferential groove 24 (better seen in FIG. 7). The lock core 16 is supported by the inner sleeve surface 20 for selective rotation within the lock sleeve 14.

The lock sleeve 16 defines two sleeve fastening grooves 184 and two sleeve fastening passages 186 extending substantially radially and circumferentially from the lock sleeve 16 (only one of the two sleeve fastening grooves 184 and two sleeve fastening passages 186 are shown in FIG. 7). The sleeve fastening passages 186 each extend between a respective sleeve fastening grooves 184 and the sleeve inner surface 20. The sleeve fastening grooves 184 are provided to receive a lock ring 82 and the sleeve fastening passages 186 are provided to allow the lock ring 82 to access the interior of the lock sleeve 16. The lock ring 82 is described in more details hereinbelow.

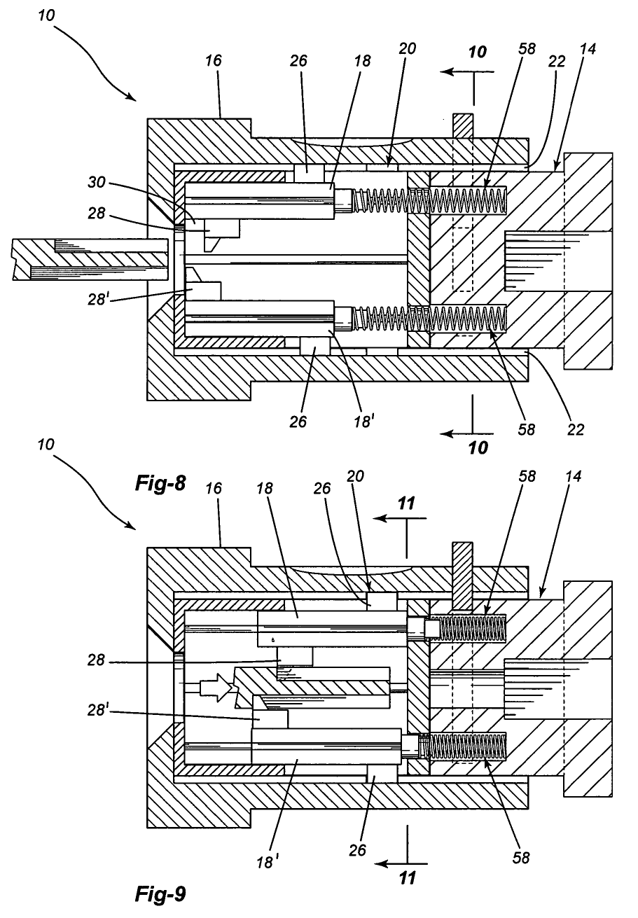

As shown on FIGS. 8 and 9, two lock pieces 18 and 18′ are slidably mounted to the lock core 14 for slidable movement relative thereto between a retracted configuration (shown on FIG. 8) and an unlocked configuration (shown on FIG. 9). While a locking assembly 10 including two lock pieces 18 and 18′ is shown in the drawings, it is within the scope of the invention to have locking assemblies including any suitable number of lock pieces, for example only one lock piece or three or more lock pieces.

As better seen in FIGS. 2, 8 and 9, the lock pieces 18 and 18′ each include a lock piece tongue 26 extending substantially outwardly from the lock core 14 and respective lock piece actuators 28 and 28′ extending substantially inwardly into the key channel 30 for selective engagement with the key 12.

In the locking assembly 10, the lock piece actuators 28 and 28′ both extend substantially radially. However, in some embodiments of the invention, the lock piece actuators are not radially oriented.

The key 12 and the lock piece actuators 28 and 28′ are complementarily configured and sized according to at least three independent directional parameters so that only a predetermined three dimensional configuration of the lock piece actuators 28 and 28′ allows for operational contact with key-to-actuator contact surface 15 upon insertion of the key 12 into the key channel 30 so as to enable the key 12 to move the lock pieces 18 and 18′ longitudinally relative to the lock core 14 from the retracted to the unlocked configuration.

In the retracted configuration, illustrated in FIG. 8, the lock core 14 is substantially prevented from rotating relative to the lock sleeve 16 by an abutting contact of the lock piece tongue 26 against the sleeve longitudinal groove 22. In the unlocked configuration, illustrated in FIG. 9, the lock piece tongue 26 is substantially in register with the sleeve circumferential groove 20 to allow a rotation of the lock core 14 relative to the lock sleeve 16.

As better seen in FIG. 2, the key stem 13 extends from a key body 17 allowing an intended user to position the key stem 13. The key stem 13 has a stem peripheral surface 32 and defines a stem longitudinal direction, represented generally by the arrow 34, a stem depth direction, represented generally by the arrow 36, extending substantially perpendicularly inwardly from the stem peripheral surface 32 and a stem circumferential direction, represented generally by the arrow 38, extending substantially tangentially to the stem peripheral surface 32. The reader skilled in the art will readily appreciate that the stem circumferential direction is a curvilinear direction that.

The key stem 13 is provided with two substantially longitudinal guiding grooves 23. The key stem 13 is further provided with substantially longitudinal key grooves 40, 42, 44, 46, 48 and 50, the key grooves 40, 42, 44, 46, 48 and 50 defining the key-to-actuator contact surface 15. While a key 12 including six key grooves 40, 42, 44, 46, 48 and 50 and two guiding grooves 23 is illustrated in the drawings, it is within the scope of the invention to have a key including any suitable number of key grooves and guiding grooves.

Only a predetermined combination of dimensional characteristics of the key grooves 40, 42, 44, 46, 48 and 50 in the stem longitudinal 34, stem depth 36 and stem circumferential 38 directions allows for operational contact with the complementarily shaped lock piece actuators 28 and 28′.

The drawings illustrate key grooves 40, 42, 44, 46, 48 and 50 that are each of substantially uniform and substantially rectangular cross-section. However, it is within the scope of the invention to have key grooves of any suitable cross-section that are or are not substantially uniform.

The key groove 40 has first and second key groove ends 52 and 54. The first key groove end 52 is open to allow the key groove 40 to receive the lock piece actuator 28. The second key groove 54 includes a portion of the key-to-actuator contact surface 15. The portion of the key-to-actuator contact surface 15 included into the second key groove 54 is substantially perpendicular to the stem longitudinal direction 34. The other key grooves 42, 44, 46, 48 and 50 are substantially similar to the key groove 40.

The reader skilled in the art will readily appreciate that while key grooves 40, 42 and 44 are not complete separated from each other by a longitudinal wall, it is within the scope of the invention to have such key grooves that are distanced from each other by such a wall.

As better seen from FIGS. 2, 8 and 9, the locking assembly 10 includes two lock piece biasing elements 56 operatively coupled to the lock pieces 18 and 18′ and to the lock core 14 for biasing the lock pieces 18 and 18′ towards the retracted configuration.

In a specific embodiment of the invention, the lock piece biasing elements each include a coil spring 58 and a contact element 60 provided between the spring 58 and the lock pieces 18 and 18′. The contact element is substantially cylindrical and is secured to the spring 58 in any suitable manner.

As better seen in FIG. 7, the lock core 14 includes an attachment portion 62 provided substantially opposite the core end surface 11, a core body 64 for receiving the lock pieces 18 and 18′, and a core end plug 66 insertable over said core body 64, the core end surface 11 being defined by the core end plug 66.

Still referring to FIG. 7, the attachment portion 62 includes a substantially cylindrical attachment portion body 74 defining an attachment portion body peripheral surface 76 and first and second substantially opposite attachment portion body end surfaces 72 and 78. An attachment portion flange 80 extends substantially outwardly from the attachment portion body peripheral surface 76.

The attachment portion 62 includes an attachment section for attaching thereto a locking mechanism actuated by the locking assembly 12. Examples of such a locking mechanisms include a latch and a bolt, among others.

In a specific embodiment of the invention, the attachment section includes an attachment bore 68 extending substantially longitudinally into the attachment portion body 74 from the second attachment portion body end surface 78. The attachment bore 68 is of a substantially square cross-section and is provided for receiving a conventional shaft that is part of conventional latches and bolts. However, it is within the scope of the invention to have any other suitable attachment section. Since attachment sections are well-known in the art, the attachment section of the attachment portion 62 will not be described in further details.

The attachment portion body peripheral surface 76 defines two core fastening grooves 70 (only one of which is shown on FIG. 7) that are substantially perpendicular to a longitudinal axis of the attachment portion body 74. The core fastening grooves 70 are provided for receiving the lock ring 82 that secures the lock core 14 to the lock sleeve 16, as described in further details hereinbelow.

The attachment portion body 74 also defines biasing element receiving bores 84 extending substantially longitudinally into said attachment portion body 74 from said first attachment portion body end surface 72. The biasing element receiving bores 84, each receiving a respective spring 58 therein. The biasing element receiving bores 84 are substantially collinear with the lock pieces 18 and 18′.

As seen in FIG. 7, the core body 64 includes a core end plate 86 extending substantially radially within the lock sleeve 16 and defining therewithin substantially longitudinal biasing element passageways 190 for receiving the biasing elements 56. As better shown in FIG. 11, the core body 64 further includes two lock piece holders 65 (only one of which is shown in FIG. 7) extending from the core end plate 86 substantially longitudinally within the lock sleeve 16.

As illustrated in FIG. 11, the lock piece holders 65 define two substantially longitudinal core grooves 87 for slidably receiving the lock pieces 18 and 18′. The lock piece holders 64 also define two substantially radial passages 88 (better shown in FIG. 11) in communication with the grooves 86 and extending between the key channel 30 and the core outer surface 88.

As seen in FIG. 7, the core body 64 includes a smaller diameter tier 112 and a wider diameter tier 114. The smaller diameter tier 112 is located proximally to the core end surface 30 with respect to the wider diameter tier 114.

The smaller diameter tier 112 is insertable within the core end plug 66. To that effect, the core end plug 66 includes a substantially annular cylindrical end plug peripheral wall 114. A substantially end plug flange 115 extends substantially inwardly from an extremity of the end plug peripheral wall 114. The end plug flange 115 defines the core end surface.

In some embodiments of the invention, substantially longitudinal ridges extend from the lock piece holders 65 into the key channel 30 and the core grooves 87. These ridges include lock piece supporting ridges 90 extending into the core grooves 87 for supporting the lock pieces 18 and 18′ within the core grooves 87, and key receiving ridges 92 extending into the key channel 30 for engaging the guiding grooves 23 and thereby guiding the insertion of the key stem 13 within the key channel 30.

The reader skilled in the art will readily appreciate that in a case wherein the two guiding grooves 23 are substantially invariant under a circumferential rotation of 180 degrees, the key 12 is insertable within the key channel 30 in two different orientations. In some embodiments of the invention, the whole key stem 13 stays invariant under a circumferential rotation of 180 degrees.

This is the case for example if in addition to the guiding grooves staying invariant under this rotation, the configurations of the key grooves 40 and 50, 42 and 48, and 44 and 46 are pair-wise substantially identical. However, in other embodiments of the invention, the key grooves 40 and 50, 42 and 48, and 44 and 46 are not pair-wise substantially identical. In these embodiments the key stem 13 will move the actuators 18 and 18′ to the unlocked configuration only when inserted within the key channel 30 in a specific orientation.

In some of these embodiments, for example in the alternative key stem 13′ shown in FIGS. 16-18, the key stem 13′ is provided with two guiding grooves 23 and 23′ having substantially dissimilar cross-sections. Having key receiving ridges of suitable substantially dissimilar cross-sections extending within the key channel 30 insures that the key stem 13′ is only insertable within the key channel 30 in a “correct” orientation that will allow to unlock the locking assembly. Another manner of achieving this result is to position the guiding grooves 23 and 23′ non-symmetrically with respect to a mid-way plane separating the key grooves 40, 42 and 44 from the key grooves 46, 48 and 50 to engage suitable key receiving ridges. In yet another alternative, only one guiding groove is provided within the key stem and only one key receiving ridge is provided within the key channel 30.

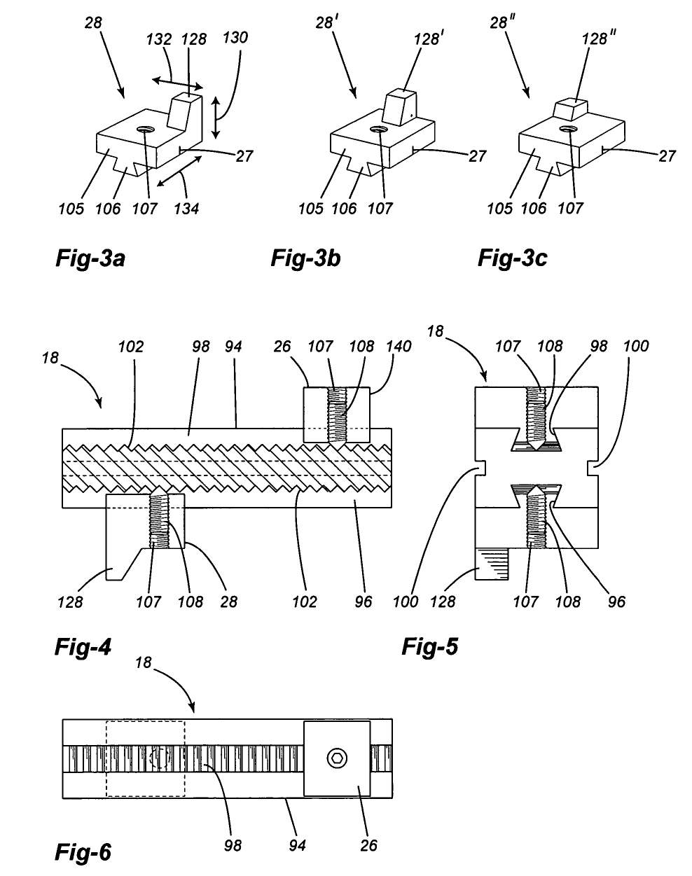

Only the lock piece 18 is described in details hereinbelow with the understanding that the lock piece 18′ is substantially similar to the lock piece 18. This description is made with reference to FIGS. 3a, 3b, 3c and 4-6.

The lock piece 18 includes a substantially elongated lock piece stem 94. The lock piece actuator 28 is selectively positionable relative to the lock piece stem. The lock piece tongue 26 is also selectively positionable relative to the lock piece stem 94. However, in some embodiments of the invention, only one of the lock piece actuator 28 and the lock piece tongue 26 is selectively positionable relative to the lock piece stem 94. In other embodiments of the invention, neither of the lock piece actuator 28 and the lock piece tongue 26 is selectively positionable relative to the lock piece stem 94. In some embodiments of the invention, lock piece tongues and actuators 26 and 28 that are not selectively positionable relative to the lock piece stem 94 extend integrally from the lock piece stem 84.

The lock piece stem 94 defines a substantially longitudinal actuator receiving groove 96 (seen in FIG. 2 for the lock piece 18′) and a substantially longitudinal tongue receiving groove 98 substantially opposed to the actuator receiving groove 96. Two lock piece guiding grooves 100 are also provided to engage the lock piece supporting ridges 90, thereby slidably mounting the lock piece 18 to the lock core 14.

Both the actuator and tongue receiving grooves 96 and 98 are open at both ends thereof. However, it is also within the scope of the invention to have actuator and tongue receiving grooves 96 and 98 that are closed at one or both ends. The actuator and tongue receiving grooves 96 and 98 are of substantially uniform substantially trapezoidal cross-section that widen in a direction directed inwardly within the actuator and tongue receiving grooves 96 and 98 grooves. The actuator and tongue receiving grooves 96 and 98 receive respectively an actuator and a tongue attachment described in further details hereinbelow.

Locking ridges 102 are provided within the actuator and tongue receiving grooves 96 and 98 for locking the lock piece actuator 28 and the lock piece tongue 26 within the actuator and tongue receiving grooves 96 and 98.

In some embodiments of the invention, stem graduations 29 are printed, engraved, embossed or otherwise marked onto the lock piece stem 18. The stem graduation 29 are provided for helping to position the lock piece actuator and tongues 28, 28′ and 26, as further detailed hereinbelow.

FIGS. 3a and 3b illustrate respectively the lock piece actuators 28 and 28′. FIG. 3c illustrate another alternative lock piece actuator 28″. The lock piece actuators 28, 28′ and 28″ are reversibly attachable to the lock piece stem 94.

The lock piece actuators 28, 28′ and 28″ each include a base 105 from which an actuator attachment 106 extends. The actuator attachment 106 is insertable within the actuator receiving groove 96. In the specific embodiment of the invention, the actuator attachment 106 is of a substantially uniform cross-section, this cross-section being substantially similar to the cross-section of the actuator receiving groove 96. The shape of these cross-section allow a relative movement between the lock piece stem 94 and the lock piece actuator 28 only in a substantially longitudinal direction.

The lock piece actuators 28, 28′ and 28″ are lockable with respect to the lock piece stem 94. To that effect, a threaded attachment bore 107 extends through the base 105 and through the actuator attachment 106. A set screw 108 is threadable into the attachment bore 107 so as to engage the locking ridges 102 and thereby lock the lock piece actuators 28, 28′ and with respect to the lock piece stem 94. However, it is within the scope of the invention to lock the lock piece actuators 28, 28′ and 28″ with respect to the lock piece stem 94 in any other suitable manner.

The lock piece actuators 28, 28′ and 28″ each defines a respective key contacting extension 128, 128′ and 128″ extending within the key channel 30. The key contacting extension 128, 128′ and 128″ are provided for abutting the key-to-actuator contact surface 15 when the key 12 moves the lock piece actuators 18 and 18′ longitudinally.

The following description refers to the key contacting extension 128 for clarity reasons with the understanding the key contacting extensions 128′ and 128″ are substantially similar to the key contacting extension 128. The following description also uses a reference frame defined by:
an actuator longitudinal direction substantially parallel to the stem longitudinal direction and illustrated by the arrow 134 on FIG. 3a;
an actuator height direction substantially parallel to the stem depth direction and illustrated by the arrow 130 on FIG. 3a; and
an actuator circumferential direction substantially parallel to the stem circumferential direction and illustrated by the arrow 132 on FIG. 3a.

The predetermined three dimensional configuration of the lock piece actuators 28 depends in part on the position of the lock piece tongue 28 26 with respect to the lock piece stem 94. The key contacting extension 128 determines other parameters that define the predetermined three-dimensional configuration of the lock piece actuators 28.

These parameters include:
a distance over which the key contacting extension 128 extends from the base 105 in the actuator height direction, hereinafter referred to as the extension height;
a relative position of the key contacting extension 128 with respect to the base 105 in the actuator circumferential direction, hereinafter referred to as the lateral position of the extension; and
a distance over which the key contacting extension 128 extends in the actuator circumferential direction, hereinafter referred to as the extension width;
a relative position of the key contacting extension 128 with respect to the lock piece stem 13 in the longitudinal direction, hereinafter referred to as the longitudinal position of the extension;
among others.

In the locking assembly 10, only the longitudinal and lateral positions of the extension and the extension height are used to vary the predetermined three dimensional configuration of the lock piece actuator 28. However, it is within the scope of the invention to use in combination any suitable number of the above-described parameters in varying the predetermined three dimensional configuration of the lock piece actuator 28.

For example, the lock piece actuator 28 differs from the lock piece actuator 28′ in the lateral position of the extension. Also, the lock piece actuator 28′ differs from the lock piece actuator 28″ both in the lateral position of the extension and in the extension height. The reader skilled in the art will readily appreciate that the lock piece actuators 28, 28′ and 28″ are only example of lock piece actuators and that many other lock piece actuators are within the scope if the invention.

In the locking assembly 10, the longitudinal position of the extension may only take discrete values determined by the ridges 102. However, it is also within the scope of the invention to have locking assemblies wherein the longitudinal position of an extension may take continuous values.

In a specific example of implementations, there are 25 possible longitudinal positions of the extension, 3 possible extension height and 3 possible lateral positions of the extension. Achieving all the possible configurations for a lock piece requires that 3×3=9 different lock piece actuators be provided, each implementing a different combination of extension height and lateral positions of the extension. Since 25 longitudinal positions of the extension are possible, in this example there are 25×9=225 different lock piece configurations achievable. This example does not take into account a possibility of achieving different combinations through a positioning of the lock piece tongue 26.

If two lock piece actuators such as those mentioned hereinabove are used in a specific locking assembly, 225×225=50625 possible three-dimensional configurations are achievable using only the limited number of actuators described in the preceding paragraph. Using more actuators increases exponentially the number of achievable configurations.

The lock piece tongue 26 is similar to the lock piece actuator 28 except that the key contacting extension 128 is replaced with a tongue extension 140 for engaging the longitudinal and circumferential outer sleeve grooves 22 and 20.

The lock piece tongue 26 is also variably positionable with respect to the lock piece stem 94. This helps making the lock piece assembly 10 secure as it is therefore not possible to determine a distance over which the lock piece 18 has to be moved to allow the lock core 14 to rotate with respect to the lock sleeve 16 by simple evaluating a distance between the extension 128 and the core end surface 30.

In some embodiments of the invention, tongue and actuator reference marks 25 and 27 are printed, engraved, embossed or otherwise marked respectively onto the lock piece tongue 26 and lock piece actuator 28,28′,28″. The tongue and actuator reference marks 25 and 27 are positioned in a predetermined relationship with a respective one of the stem graduation 29 when positioning the lock piece actuator and tongues 28, 28′ and 26 with respect to the lock piece stem 94. Therefore, tongue and actuator reference marks 25 and 27 and the stem graduations 29 allow to decrease in a time required to perform this positioning. Graduations and reference marks and their location onto objects to position with respect to each other are well-known in the art and will therefore no be described in further details.

FIG. 14 illustrates an alternative lock piece 18″. The lock piece 18″ is similar to the lock piece 18 except that it includes the two lock piece actuators 28 and 28′. However, alternative lock pieces including any two suitable alternative lock piece actuators are within the scope of the invention. The two lock piece actuators 28 and 28′ define respective key contacting extensions 128 and 128′ that are at least in part non-overlapping in either of the actuator circumferential and actuator height direction.

The lock piece 18″ allows to have two different keys that position the lock piece 18″ so as to allow the lock core 14 to rotate with respect to the lock sleeve 16. In a specific example, one of the keys is a master key that may open a plurality of locking assemblies and the other key is a sub-master key that may open only a specific locking assembly from the plurality of locking assemblies. Master and sub-master keys are well known in the art and will therefore not be described in further details.

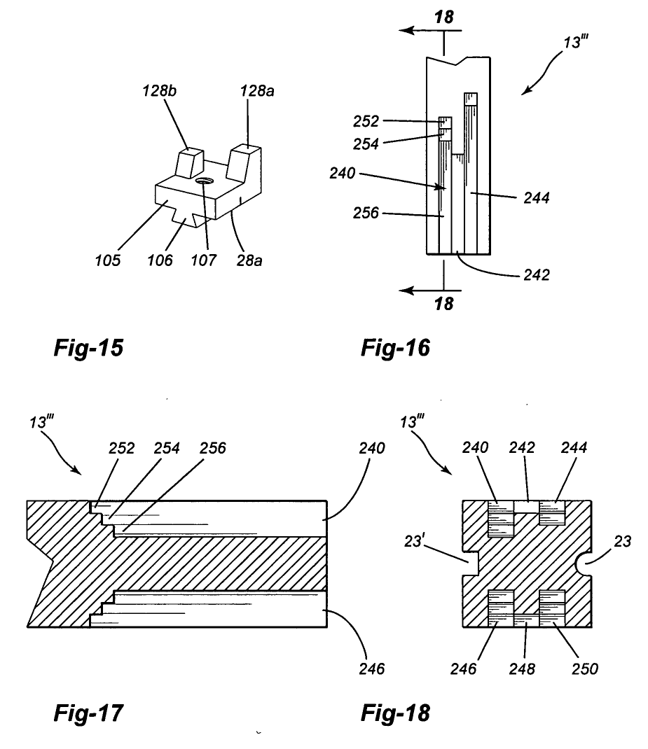

A similar result is obtainable through the use of lock piece actuators similar to the lock piece actuator 28a shown in FIG. 15. This lock piece actuator 28a is similar to the lock piece actuator 28 except that it includes two key contacting extension 128a and 128b. Therefore, the lock piece actuator 28a may be engaged by more than one key and still allow the positioning of a lock piece into an unlocked configuration.

Alternatively, the lock piece actuator 28a and similar multi-key contacting extension containing lock piece actuators engage only one key with each key contacting extension 128a and 128b engaging a respective key groove.

An issue that may occur in the above-described locking assembly is related to the issue generally known under the name of cross keying. Indeed, the reader skilled in the art will readily appreciate that key contacting extensions of different height may be suitably engaged by key grooves that have a depth equal to or larger than more than one of the allowed key contacting extension heights. For example, is three such heights are allowed, a groove of a depth equal to the maximal height will move lock piece actuators having key contacting extensions similarly located but having different extension heights. This is caused by the longitudinal uniformity of the cross-section of the key grooves.

If this issue is undesirable, it may be avoided in many alternative manners. In a first manner, the cross keying issue is avoided at least in part through the manufacturing of keys having three-dimensional configurations selected so as to avoid this issue. The relatively large number of possible three-dimensional configurations achievable with the claimed invention allows this selection to be performed while keeping a relatively large number of usable three-dimensional configurations.

Another manner of avoiding this issue includes having a key stem 13′ including multi-tiered key grooves, as shown in FIGS. 16, 17 and 18. The key stem 13′ defines key grooves 240, 242, 244, 246, 248 and 250 similar to the key grooves 40, 42, 44, 46, 48 and 50 except that at least one of the key grooves 240, 242, 244, 246, 248 and 250 is a multi-tiered groove including a first key groove tier and a second key groove tier adjacent the first key groove tier. The first and second key groove tiers are longitudinally offset relative to each other, the first key groove tier extending within the key stem in the stem depth direction over a distance substantially smaller than a distance over which the second key groove tier extends within the key stem in the stem depth direction.

For example, the key groove 240 is a three-tiered key groove including a first key groove tier 252, a second key groove tier 254 and a third key groove tier 256. The depth of each of the first, second and third key groove tiers 252, 254 and 256 increases from the first key groove tier 252 towards the third key groove tier 256. The first key groove tier 252 is distal from the first key groove end 52 and the third key groove tier 256 is proximal to the first key groove end 52. The second key groove tier 254 is provided between the first and third key groove tiers 252 and 256. The reader skilled in the art will readily appreciate that while the key groove 252 is three-tiered, key grooves having any suitable number of tiers are within the scope of the claimed invention.

In some embodiments of the invention, a locking assembly includes key contacting extensions wherein the key contacting extension height may take only a finite set of discrete value. Then, key grooves having multi-tiered key grooves that have depths that may take values substantially identical to these discrete values of extension height are used in some embodiments of the invention. Only key grooves having suitably configured tiers allow unlocking this type of locking assembly. The following non-limiting example illustrates this point better.

Say for example that in such a locking assembly the key contacting extension height may take only three values, hereinafter referred to as the small height, the medium height and the large height, the values increasing from the small height to the large height. In this example, the key grooves may be one-, two- or three-tiered with tiers of substantially uniform depth. The key stem 13′ is a non-limiting example of such a key.

More specifically, some key grooves, such as key groove 242, have only one tier of a depth substantially equal to the small height. Other key grooves, such as key groove 244, have two tiers, one of the two tiers having a depth substantially equal to the medium height and the other tier having a depth substantially equal to the small height. Finally, yet other grooves, such as key groove 240, have three tiers of a depth substantially equal respectively to the small, medium and large height.

Now suppose that the key stem 13′ is configured so that when the key stem 13′ moves the lock pieces 18 and 18′ longitudinally relative to the lock core 14 from the retracted to the unlocked configuration, the unlocked configuration is achieved if a key contacting extension received within the key groove 240 is of a large height. Accordingly, this key contacting extension is received within the third key groove tier 256 but excluded from the second and first key groove tiers 254 and 252.

If the key stem 13′ is inserted within a key channel of a lock core into which an alternative key contacting extension of medium height is in register with the key groove 240, this alternative key contacting extension will be received sequentially by the third key groove tier 256 and by the second key groove tier 254 to be subsequently excluded from the first key groove tier 252. Accordingly, a lock piece actuator to which the key contacting extension of medium height is connected is then moved longitudinally over a distance that does not result in an unlocked configuration and the locking assembly stays locked.

The reader skilled in the art will readily appreciate that in a situation wherein a key contacting extension has a height larger than the depth of the deepest key groove tier of a key groove is totally prevented from entering this key groove and therefore leads also to a situation wherein the unlocked configuration is not achieved.

While a specific multi-tiered structure has been presented hereinabove, the reader skilled in the art will readily appreciate that any other suitable multi-tiered grooves or other structures are within the scope of the claimed invention.

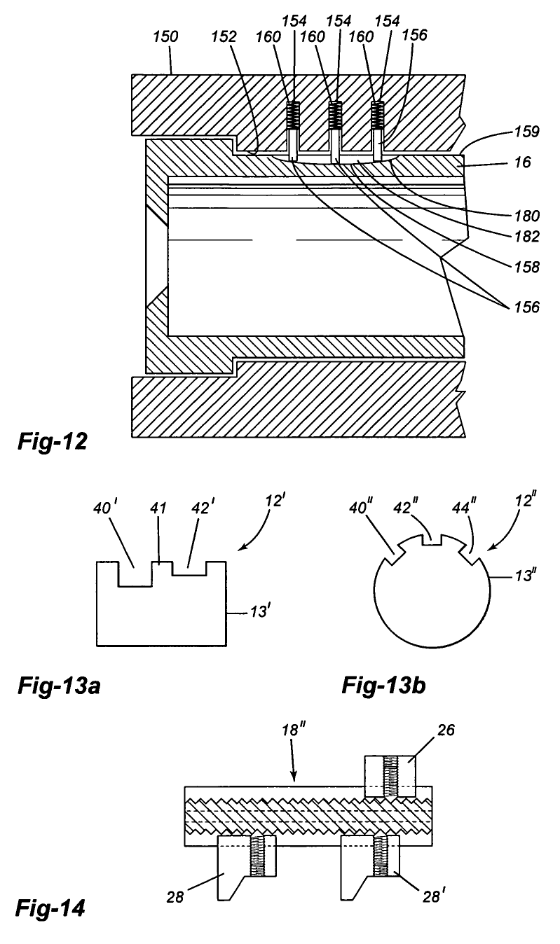

While not a necessary feature of all the embodiments of the invention, the locking assembly 10 is retrofittable to a conventional lock. FIG. 12 illustrate schematically this retrofit.

The conventional lock includes a substantially cylindrical external sleeve 150 defining an external sleeve inner surface 152. The external sleeve 150 also defines three substantially radial shafts 154 extending from the external sleeve inner surface 152. A pin 156 is received within each of the shafts 154 and protrudes at least in part outwardly therefrom.

The lock sleeve 16 is inserted within the external sleeve 150. More specifically, the lock sleeve 16 is supported within the external sleeve 150 by the external sleeve inner surface 152.

The lock sleeve 16 defines an outer sleeve surface 159 provided with a recess 158 therewithin for receiving the pins 156 so that the lock sleeve 16 is substantially prevented from rotating with respect to the external sleeve 152.

In some embodiments of the invention, a pin biasing element 160 in the form of a coil spring is provided at least in part within each shaft 154 to bias the pins 156 biased towards the lock sleeve 16. In these embodiments, an example of a suitable recess 158 includes a substantially arcuate recess bottom wall 180 substantially perpendicular to two substantially planar side walls 182 extending from the recess bottom wall 180. This configuration of the recess 158 allows to remove the lock sleeve 16 form the external sleeve 150 through a substantially longitudinal relative movement therebetween. However, it is within the scope of the invention to have any suitable alternative recess.

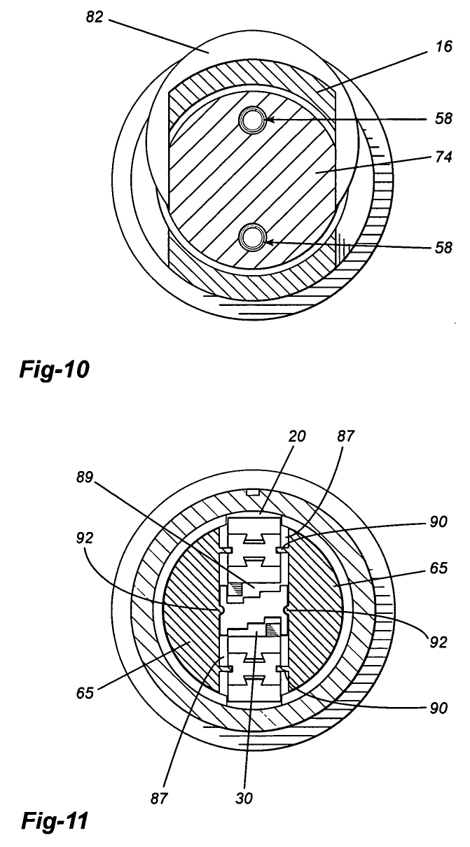

As better seen in FIG. 10, the locking assembly 10 further includes the lock ring 82. The lock ring 82 is substantially horse-shoe shaped and locks longitudinally the lock core 14 within the lock sleeve 16 by engaging the core and sleeve fastening grooves 70 and 184.

To assemble the locking device 10, suitable lock piece actuators 28, 28′ or 28″, among others, are selected so that the key 12 and the lock piece actuators are complementarily configured and sized according to at least three independent directional parameters so that only a predetermined three dimensional configuration of the lock piece actuators allows for operational contact with key-to-actuator contact surface 15 upon insertion of the key 12 into the key channel 30 so as to enable the key 12 to move the lock pieces 18 and 18′ longitudinally relative to the lock core 14 from the retracted to the unlocked configuration.

Then, the lock piece tongue and actuator 26 and 28,28′, 28″ are poisoned at suitable locations onto the lock piece stem 28 and secured using the set screw 108. Subsequently, biasing elements 58 are inserted into the biasing element passageways 190 and the biasing element receiving bores 84. The actuators 18 and 18′ are then slid over the actuator receiving ridges 90 and the core end plug 66 is pressed towards the attachment portion 62 with the core body 64 suitably positioned therebetween.

This allow to insert the lock core 14 within the lock sleeve 16 and to secure the lock core 14 to the lock sleeve 16 using the lock ring 82 as described hereinabove and to position the lock sleeve 96 within a conventional cylinder lock or within any other suitable enclosure if required.

When the key stem 13 is inserted within the key channel 30, the key receiving ridges 92 guide the key stem 13. As illustrated in FIG. 8, at first the lock pieces 18 and 18′ are in the retracted configuration. In this configuration, the lock piece tongues 26 are not in register with the sleeve circumferential groove 20 and as such prevent a rotation of the lock core 14 with respect to the lock sleeve 16.

Further to an insertion of the key stem 13 into the key channel 30 over a suitable distance, as shown in FIG. 9, the lock pieces 18 and 18′ are in the unlocked configuration. In this configuration, the lock piece tongues 26 are substantially in register with the sleeve circumferential groove 20 and as such allow a rotation of the lock core 14 with respect to the lock sleeve 16. In some embodiments of the invention, the suitable distance is achieved upon the key body 17 abutting the lock sleeve 16, but this is not necessarily the case in all embodiments of the invention.

The unlocked configuration is achieved when the a key-to-actuator contact surface 15 abuts the key contacting extension 128 and 128′ and thereby push onto the lock pieces 18 and 18′ against the biasing elements 56 when the key stem 13 is inserted into the key channel 30.

Removing the key stem 13 from the key channel allows the lock pieces 18 and 18′ to get back to the retracted configuration through the action of the biasing elements 56.

In some embodiments of the invention, exchanging lock piece actuators involves simply to remove the lock core 14 from the lock sleeve 16 and to remove the core end plug 66 to access the lock pieces. This access is facilitated by the two-tiered configuration of the core body 64.

Also, while the key 12 includes a stem 13 of a substantially parallelepipedal shape. It is within the scope of the invention to have key stems 13 having any other alternative shapes. Examples of such keys 12′ and 12″ are shown schematically respectively in FIGS. 13a and 13b. However, it is within the scope of the invention to have any other suitable alternative key. Also, the reader skilled in the art will readily conceive alternative lock cores and sleeves and lock pieces that are usable in conjunction with the keys 12′ and 12″.

The key 12′, shown in FIG. 13a, includes a key stem 13′ of a substantially parallelkepipedal cross-section. Two grooves 40′ and 42′ similar to the grooves 40 and 42 are provided. However, the grooves 40′ and 42′ are separated from each other by a wall 41 extending therebetween along their whole length. The key 12″, shown in FIG. 13b, includes a key stem 13′ of a substantially circular cross-section.

In yet other embodiments of the invention, a key and lock piece actuators are complementarily configured and sized according to any suitable number of independent directional parameters so that only a predetermined configuration of the lock piece actuators allows for operational contact with key-to-actuator contact surface upon insertion of the key into the a key channel so as to enable the key to move the lock pieces longitudinally relative to the lock core from the retracted to the unlocked configuration.

Although the present invention has been described hereinabove by way of preferred embodiments thereof, it can be modified, without departing from the spirit and nature of the subject invention as defined in the appended claim.

1. A locking assembly, comprising:
a. a key having a key stem, said key stem defining a key-to-actuator contact surface;
b. a lock sleeve defining an inner sleeve surface, said inner sleeve surface defining a substantially longitudinal sleeve longitudinal groove and a substantially circumferential sleeve circumferential groove;
c. a substantially cylindrical lock core defining a core end surface, a core outer surface extending substantially longitudinally from said core end surface, and a key channel extending substantially longitudinally from said core end surface for allowing insertion thereinto of said key, said lock core being supported by said inner sleeve surface for selective rotation within said lock sleeve;
d. a lock piece slidably mounted to said lock core for slidable movement relative thereto between a retracted configuration and an unlocked configuration, said lock piece including
i. a lock piece tongue extending substantially outwardly from said core outer surface;
ii. a lock piece actuator extending substantially inwardly into said key channel for selective engagement with said key;
e. said key and said lock piece actuator being complementarily configured and sized according to three independent directional parameters so that only a predetermined three dimensional configuration of said lock piece actuator allows for operational contact with said key-to-actuator contact surface upon insertion of said key into said key channel so as to enable said key to move said lock piece longitudinally relative to said lock core from said retracted to said unlocked configuration;
f. wherein in said retracted configuration said lock core is substantially prevented from rotating relative to said lock sleeve by an abutting contact of said lock piece tongue against said sleeve longitudinal groove and in said unlocked configuration said lock piece tongue is substantially in register with said sleeve circumferential groove to allow a rotation of said lock core relative to said lock sleeve.

2. A locking assembly as defined in claim 1, wherein:
a. said key stem has a stem peripheral surface and defines a stem longitudinal direction, a stem depth direction extending substantially perpendicularly inwardly from the stem peripheral surface and a stem circumferential direction extending substantially tangentially to the stem peripheral surface
b. said stem is provided with a substantially longitudinal key groove, said key groove defining said key-to-actuator contact surface; and
c. only a predetermined combination of dimensional characteristics of said key groove in the stem longitudinal, stem depth and stem circumferential directions allow for operational contact with said complementarily shaped lock piece actuator.

3. A locking assembly as claimed in claim 2, further comprising:
a. a substantially cylindrical external sleeve defining an external sleeve inner surface, said external sleeve also defining a substantially radial shaft extending from said external sleeve inner surface;
b. a pin received within said shaft and protruding at least in part outwardly therefrom;
c. wherein said lock sleeve is inserted within said external sleeve, said lock defining an outer sleeve surface provided with a groove therewithin for receiving said pin so that said lock sleeve is substantially prevented from rotating with respect to said external sleeve.

4. A locking assembly as claimed in claim 3, further comprising a pin biasing element provided at least in part within said shaft and biasing said pin towards said lock sleeve.

5. A locking assembly as claimed in claim 4, wherein said lock sleeve is supported within said external sleeve by said external sleeve inner surface.

6. A locking assembly as claimed in claim 2, further comprising a lock piece biasing element operatively coupled to said lock piece and to said lock core for biasing said lock piece towards said retracted configuration.

7. A locking assembly as claimed in claim 6, wherein said lock core includes an attachment portion provided substantially opposite said core end surface, said attachment portion defining an attachment section for attaching thereto a locking mechanism actuated by said locking assembly.

8. A locking assembly as claimed in claim 7, wherein said attachment portion is releasable from said lock core.

9. A locking assembly as claimed in claim 8, wherein: said lock core is provided with:
a. a substantially longitudinal core groove for slidably receiving said lock piece therewithin;
b. a substantially radial passage in communication with said core groove and extending between said key channel and said core outer surface.

10. A locking assembly as claimed in claim 9, wherein said lock piece includes a lock piece stem, said lock piece actuator being selectively positionable relative to said lock piece stem.

11. A locking assembly as claimed in claim 10, wherein said lock piece actuator is removably attached to said lock piece stem.

12. A locking assembly as claimed in claim 9, wherein said lock piece tongue is selectively positionable relative to said lock piece stem.

13. A locking assembly as claimed in claim 12, wherein said lock piece tongue is removably attached to said lock piece stem.

14. A locking assembly as claimed in claim 9, wherein said lock piece includes two lock piece actuators offset at least in part relative to each other for allowing operational contact with a master key and a conventional key respectively.

15. A locking assembly as claimed in claim 9, wherein said lock piece actuator includes at least two key contacting at least in part relative to each other for allowing operational contact with a master key and a conventional key respectively.

16. A locking assembly as claimed in claim 2, wherein said key groove is a multi-tiered key groove including a first key groove tier and a second key groove tier adjacent said first key groove tier, said first and second key groove tier being longitudinally offset relative to each other, said first key groove tier extending within said key stem in the stem depth direction over a distance substantially smaller than a distance over which said second key groove tier extends within said key stem in the stem depth direction.

17. A locking assembly as claimed in claim 1, comprising:
a. A plurality of lock pieces slidably mounted to said lock core, each for slidable movement relative thereto between a retracted configuration and an unlocked configuration, each of said lock piece including
i. a lock piece tongue extending substantially outwardly from said core outer surface;
ii. a lock piece actuator extending substantially inwardly into said key channel for selective engagement with said key;
b. said key and said lock piece actuators being complementarily configured and sized according to three independent directional s so that only a predetermined three dimensional configuration of said lock piece actuators allows for operational contact with said key-to-actuator contact surface upon insertion of said key into said key channel so as to enable said key to move said lock piece longitudinally relative to said lock core from said retracted to said unlocked configuration;
c. wherein in said retracted configuration said lock core is substantially prevented from rotating relative to said lock sleeve by an abutting contact of at least one of said lock piece tongues against said sleeve longitudinal groove, and in said unlocked configuration all of said lock piece tongues are substantially in register with said sleeve circumferential groove to allow a rotation of said lock core relative to said lock sleeve.
